(19) United States
(12) Patent Application Publication
(10) Pub. No.: US 2008/0255949 A1
(43) Pub. Date: Oct. 16, 2008

(54) Method and System for Measuring Non-Verbal and Pre-Conscious Responses to External Stimuli

(75) Inventors: Stephen J. Genco, Sunnyvale, CA (US); Fernando Miranda, Tiburon, CA (US); Jennifer Mangels, New York, NY (US); David Remer, Seattle, WA (US)

Correspondence Address: Stephen;Genco, 1554 Barton Drive, Sunnyvale, CA, 94087, US

(73) Assignee: LUCID SYSTEMS, INC., Seattle, WA (US)

(21) Appl. No.: 12/101,093

(22) Filed: Apr. 10, 2008

Related U.S. Application Data
(60) Provisional application No. 60/911,629, filed on Apr. 13, 2007.

(51) Int. Cl. G06Q 30/00

(52) U.S. Cl. 705/14

(57) ABSTRACT

Systems and methods of employing experimental tasks, neurological and physiological recording devices, and a sequenced process of data acquisition and analysis to produce measurements of pre-verbal and pre-conscious brain processes. An array of measurement devices are connected non-invasively to an individual (the subject). The subject experiences one or more external stimuli via any combination of senses, including visual, auditory, tactile, olfactory, and/or gustatory. Experimental tasks, data acquisition, analysis, and/or presentation steps are processed to ascertain the subject's pre-verbal and pre-conscious responses to the external stimuli, including attentional triggering, emotional valence and arousal, interest, engagement, and activation of higher cognitive processes such as memory, preference formation, and decision making.

### REFERENCE TO RELATED APPLICATIONS

This application claims priority from U.S. Provisional Patent Application No. 60/911,629, filed Apr. 13, 2007. U.S. Provisional Application No. 60/911,629 is hereby incorporated herein by reference in its entirety.

### BACKGROUND OF THE INVENTION

1. Field of the Invention

The present invention relates generally to the field of consumer research methods for identifying emotional and cognitive responses to product and marketing stimuli.

2. Background Description

Consumer responses to products and messages have traditionally been measured with verbal and written self-reports of conscious reactions. These measures are often referred to in the research literature as explicit measures. They make several assumptions about a person's relationship to a stimulus that may or may not be true; for example, they typically assume that the person:

(a) has already formed an opinion or is able to construct one on the spot,

(b) is aware of (i.e., has conscious access to) his or her attitude, and

(c) is willing to share it accurately with the researcher.

Examples of explicit measurement techniques include focus group interviews, telephone surveys, paper-and-pencil questionnaires, online surveys, and instrument-mediated measurement systems using sliders or dials to capture moment-to-moment changes in emotional reactions. Responses measured include stated preferences among alternative products or messages, propensities to buy, likelihood of use, aesthetic judgments of product and packaging designs, moment-to-moment affective responses, and other predictions of likely future behaviors.

These measures can be flawed and biased in several ways, and often do not product accurate, consistent or reproducible results (Poels, K. and Dewitte, S. (2005). How to capture the heart? Reviewing 20 years of emotion measurement in advertising. Working Paper MO 0605. Dept. of Marketing and Organization Studies, Catholic University of Leuven, Leuven, Belgium.). Some reasons that have been cited for this effect include:
(a) People are not consciously aware of many of the things they do and like in daily life, so cannot accurately apply cognitive labels to their behaviors and attitudes
(b) Emotional reactions can influence behavior without being consciously experienced
(c) Even when consciously experienced, emotions may be difficult to label accurately
(d) Social desirability concerns can distort self-reports. For example, people inflate ratings to justify their time and effort, they respond in a manner that they believe is expected of them, and they modify their responses on sensitive topics or if they believe their true attitudes are not socially acceptable (Gladwell, M. (2005). Blink: The Power of Thinking Without Thinking. New York, N.Y. Little Brown.).

Recently, researchers have begun measuring naturally occurring biological processes to overcome some of these biases of self-reporting. These measures are often referred to in the research literature as implicit measures. By recording and analyzing naturally occurring biological activity, researchers have gained insights into how the mind and body respond to messages (Lang, A. (1994). What can the heart tell us about thinking. In A. Lang (Ed.),Measuring psychological responses to media (pp. 99-111). Hillsdale, N.J.: Lawrence Erlbaum Associates, Inc.; Ravaja, N. (2004). Contributions of psychophysiology to media research: Review and recommendations. Media Psychology, 6, 193-235.) and products (Chartrand, T. (2005). The role of conscious awareness in consumer behavior. Journal of Consumer Psychology, 15(3), 203-210.). Conscious introspection has been shown to include only a narrow band of the processes that happen in the brain. The vast majority of human biological and cognitive functions are governed by processes in the brain and nervous system that are well below the threshold of conscious perception.

Although humans do not have cognitive access to these low-level biological functions, they can provide important clues about how consumers pre-verbally and pre-consciously respond to products, media and messaging (Fitzsimons, G., et al. (2002). Non-Conscious Influences on Consumer Choice. Marketing Letters 13:3, 269-279.). At any moment, a person may be lost in thought or focused on a conversation, but the body is preparing itself to be able to act appropriately. If we are experiencing something we want or desire, our body is preparing to move toward it. In this sense, the body is constantly making hypotheses about the appropriate next action, and neural and psychophysiological measurements allow provide a window into these somatic predictions. By knowing what the brain and body are doing below the level of consciousness, we can better understand psychological events like responses to products and messages. That is, cognition is an embodied phenomenon (Bradley, S. D. (2007a). Dynamic, embodied limited-capacity attention and memory: Modeling cognitive processing of mediated stimuli. Media Psychology, 9, 211-239.; Bradley, S. D. (2007b). Examining the Eyeblink Startle Reflex as a Measure of Emotion and Motivation to Television Programming. Communication Methods and Measures, 1(1), 7-30, 9, 211-239.; Clark, A. (1997). Being there: Putting brain, body, and world together again. Cambridge, Mass.: MIT Press.).

But available neural and physiological measures that constitute current art also have limitations. The most important limitation for the purposes of consumer research is that each measure, by itself, is an incomplete and unreliable indicator of a person's emotional and cognitive response to a stimulus (Andreassi, J. (2007). Psychophysiology: human behavior and physiological response. Fifth edition. Mahwah, N.J.: Lawrence Erlbaum.). Facial electromyography (EMG), for example, provides a reliable measure of emotional valence or liking, but does not measure emotional arousal or excitation. Electrodermal activity (EDA), such as skin conductance response, provides an accurate measure of emotional arousal, but not of directional valence. Other measures, such as event related potentials (ERP), are reliable only in a multi-exposure experimental task, because averaging across trials is required to suppress electrical signal noise not associated with the stimulus being measured (Luck, S. (2005). An introduction to the event-related potential technique. Cambridge, Mass.: MIT Press.).

A second limitation with individual neural and physiological measures is that different individuals have different baseline levels of activity that can bias aggregated results when measures are combined or averaged across a sample of consumers. These differences may be strictly individual; for example, a person with peripheral vascular disease manifests lower average skin conductance responses to any stimulus than a person with normal vascular functionality. More generally, one person may display large changes in electrodermal activity with increased emotional arousal and show only moderate changes in heart rate and peripheral blood flow volume, while another individual may show the reverse pattern. Differences may also be age or gender-related; for example, men on average manifest higher skin conductance responses than women, but lower EMG responses (Bradley, M. M. et al. (2001). Emotion and Motivation II: Sex Differences in Picture Processing. Emotion, 1(3), 300-319.). Brainwave activity associated with cogitation varies by age, with older people exhibiting a slowing of the EEG as compared to younger people (Klimesch, W. (1999). EEG alpha and theta oscillations reflect cognitive and memory performance: a review and analysis. Brain Research Reviews 29, 169-195.).

When multiple neural and physiological measures are collected simultaneously, a third limitation is that they measure activity that occurs at different time scales (Andreassi, J. (2007). Psychophysiology: human behavior and physiological response. Fifth edition. Mahwah, N.J.: Lawrence Erlbaum.). Neural responses measured by direct brain processing recordings, such as continuous electroencephalography (EEG), occur in milliseconds. Muscle movement responses measured by EMG also occur in milliseconds, but with a consistent time lag proportional to time required to transmit a signal to the muscle being measured. Autonomic nervous system arousal responses, such as electrodermal activity measured by skin conductance response (SCR), occur on a much slower time scale, occurring between one and two seconds after stimulus exposure, and lasting up to four or five seconds.

Accordingly, there is a need for systems and methods of measuring consumer responses to external stimuli that avoid, or at least alleviate, these limitations and provide accurate and replicable measures of pre-verbal and pre-conscious, as well as conscious, responses. There is also a need to integrate and aggregate these measures to provide improved and more accurate analyses and research results than can be produced with prior art.

Much prior art related to the current invention addresses a purpose other than consumer research, such as medical diagnosis or training feedback. For example:
(a) U.S. Pat. No. 3,855,998 by Hidalgo-Briceno, the earliest patent to incorporate EEG and EDA to measure emotional state, employs these measures to drive a biofeedback entertainment unit.
(b) U.S. Pat. No. 6,947,790 by Gevins and patents referenced therein describe methods for improving EEG data collection, analysis or inferences for medical diagnosis purposes.
(c) U.S. Pat. No. 5,230,346 by Leuchter and related patents describe methods for using EEG measures in the diagnosis of brain conditions.
(d) U.S. Pat. No. 7,285,090 by Stivoric and references therein describe a multi-measurement system utilizing a wide range of sensors and metrics for the purpose of tracking overall health and well-being. The system measures overall tonic levels, not point-in-time responses to specific stimuli (see also U.S. Pat. No. 6,605,038 by Teller).
(e) U.S. Pat. No. 5,762,611 by Lewis describes the use of ERP measures to evaluate interest in educational and training materials.

Much prior art focuses on a single metric solution, an incomplete subset of metrics, or a single sensory modality. For example:
(a) U.S. Pat. App. No. 20030032890 by Hazlett and references therein address EMG as a measure of emotional valence, but do not integrate it with complementary measures of emotional arousal.
(b) U.S. Pat. No. 7,113,916 by Hill and references therein utilize facial expression analysis to measure consumer responses to marketing stimuli.
(c) U.S. Pat. Nos. 6,099,319 and 6,315,569 by Zaltman focus on the use of neuroimaging (positron emission tomography, functional magnetic resonance imaging, magnetoencephalography and single photon emission computer tomography) to collect brain functioning data while exposed to marketing stimuli and performing experimental tasks (e.g., metaphor elicitation).
(d) U.S. Pat. No. 6,453,194 by Hill utilizes synchronized EMG and EDA signals to measure reactions to consumer activities, but does not include modalities such as brain activity measurement or pupilometry in its array of recording devices.
(e) U.S. Pat. No. 6,584,346 by Flugger describes a multi-modal system and process for measuring physiological responses using EDA, EMG, and brainwave measures, but only for the purpose of assessing product-related sounds, such as the sounds of automobile mufflers.

Prior art has significant limitations with respect to measurement of pre-verbal and pre-conscious responses to external stimuli, including:
(a) U.S. Pat. No. 5,243,517 by Schmidt describes a method for using EEG and ERP to measure attention and cognition while viewing an advertisement. The method includes no measures of emotional response to the advertisement, either conscious, pre-conscious, or pre-verbal. Similar goals and limitations are evident in U.S. Pat. No. 6,292,688 by Patton, which discloses a method for measuring emotional responses to advertisements using EEG brainwave frequency analysis.
(b) U.S. Pat. No. 5,676,138 by Zawilinski describes and emotional response analyzer system, but does not include modalities such as brain activity measurement or pupilometry in its array of recording devices. This and related patents (e.g., U.S. Pat. No. 6,656,116 by Kim) focus on measuring tonic emotional states, rather than emotional responses to specific stimuli introduced in an experimental setting.
(c) U.S. Pat. No. 4,955,388 by Silberstein measures attention to multimedia stimuli including advertisements, but does not include measures of implicit or explicit emotional response or memory.

Although much prior art addresses methods for acquiring consumer research data (for example, U.S. Pat. No. 7,308,418 by Malek, U.S. Pat. No. 5,124,911 by Sack, U.S. Pat. No. 7,151,540 by Young, and references therein), none specifically describes a complete system and method for collecting, analyzing, and interpreting pre-verbal and pre-conscious responses to external stimuli such provided by aspects of the current invention.

### SUMMARY OF THE INVENTION

Methods and systems for recording and metricizing neurological and physiological responses to stimuli, and translating these recordings into quantitative measures of central and peripheral nervous system processes that occur pre-verbally and are not directly accessible to conscious awareness.

An embodiment of the present invention generates data from a configuration of experimental tasks, neurological and physiological recording devices, and a sequenced process of data acquisition and analysis that produces quantitative measures of pre-verbal and pre-conscious brain processes.

Utilizing the invention, an investigator can measure how a person responds to a stimulus at a pre-verbal or pre-conscious level. Results from the recording and analysis process are used to calculate neurometric indicators of human responses to stimuli that can be compared to, or serve as an alternative to, more traditional self-reporting measures, such as interviews and survey results.

Aspects of the current invention utilize the principle of “triangulation” across multiple neurological and physiological measurement modalities to improve the accuracy and reliability of consumer response measures. Rather than relying on any single measure, aspects of the invention combine and synchronize multiple measures, employing an integrated and aggregated combination of neurological and physiological modalities to achieve superior accuracy and reliability as compared to prior art.

### BRIEF DESCRIPTION OF THE DRAWINGS

Embodiments of the invention are illustrated by way of example, and not by way of limitation, in the figures of the accompanying drawings, in which like reference numbers refer to similar elements.

FIG. 1 is a block diagram of the system and process flow that comprise one embodiment of the invention.

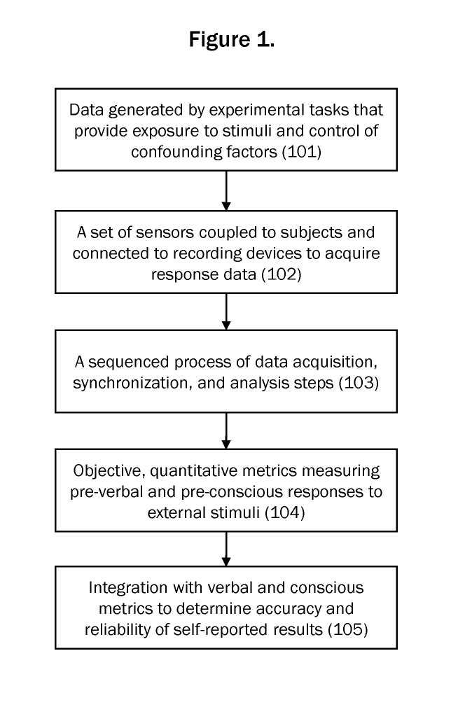

FIG. 2 is a top-down schematic diagram of the configuration of a subject, sensor locations on this skin and scalp of the subject, and recording, processing, and storage devices that comprise the data acquisition system and process in one embodiment of the invention.

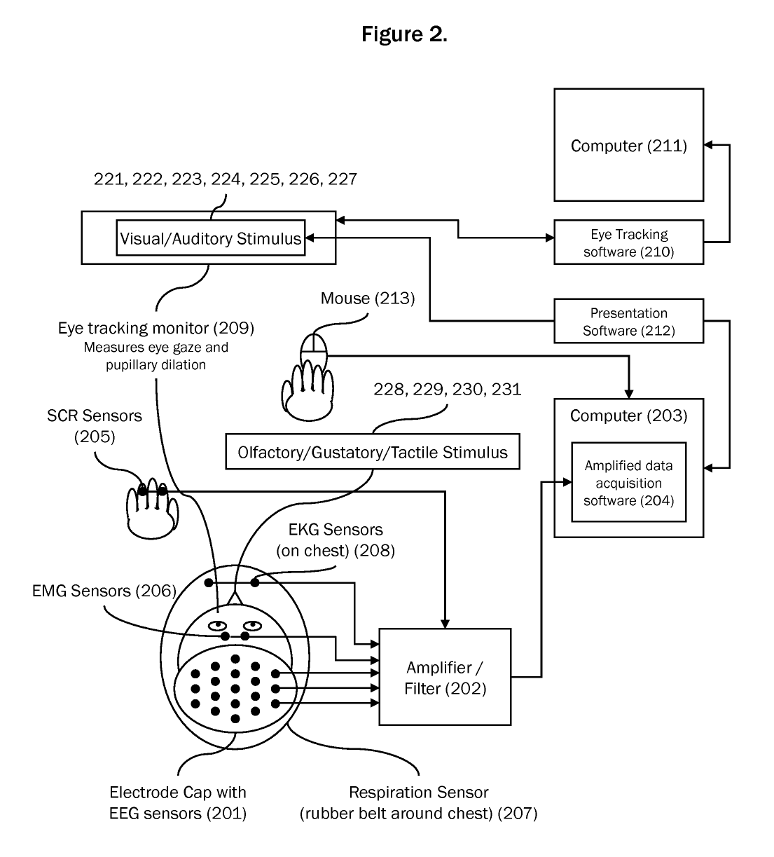

FIG. 3 is a block diagram of the data flow, data reduction, data synchronization, data consolidation, data analysis, and data presentation process and steps in one embodiment of the invention.

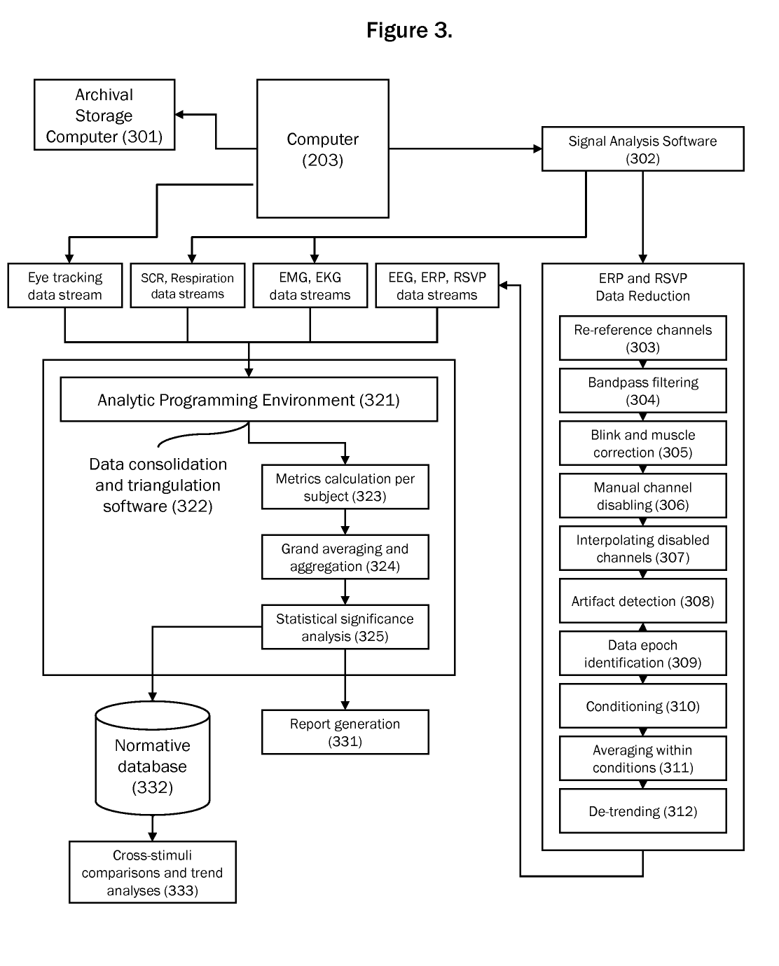

### DETAILED DESCRIPTION OF THE INVENTION

An embodiment of the invention is a configuration of:
(a) Data generated by experimental tasks (101) that expose subjects to target external stimuli and elicit pre-verbal and pre-conscious responses to those stimuli,
(b) a set of sensors, coupled to the human subject and connected to a set of recording devices (102) that capture and store raw neural and physiological signals produced before, during, and after exposure to external stimuli, and
(c) a step-by-step method for evaluation a set of select responses of a human subject exposed to external stimuli, comprised of a data acquisition and analysis process (103) that translates signal data, recorded by a set of devices, into integrated and aggregated metrics to detect and quantify pre-verbal and pre-conscious responses correlated with a stimulus exposure.

Together, these elements are incorporated in computer instructions on a storage medium that, based on at least a portion of the information received from the set of sensors, determines:
(d) at least one metric (104) corresponding to the set of selected responses that objectively describe pre-verbal and pre-conscious responses, including attention, attraction, emotional response, and memorability, to external stimuli such as products, advertisements, marketing messages, and entertainment programming,
(e) when combined with traditional verbal and self-reporting measures, at least one metric that objectively describes the accuracy and reliability of verbal and self-reporting measures as compared to pre-verbal and pre-conscious measures (105).

The terms “pre-conscious response” and “pre-conscious reaction” are used interchangeably and refer to a response to stimuli that occurs in the brain or body, but that the subject is not consciously aware of. Pre-conscious responses include, but are not limited by, electrical activity in the brain and physiological responses in the autonomic nervous system (ANS).

The terms “pre-verbal response” and “pre-verbal reaction” are used interchangeably and refer to a response to stimuli that may or may not be “conscious,” in the sense that a subject is aware of the response, but are not verbal, in the sense that the response itself is verbalized, written down, or otherwise self-reported by the subject, or occurs prior to verbalization by the subject. All pre-conscious responses are pre-verbal, but some pre-verbal responses may not be pre-conscious.

The term “pre-verbal and pre-conscious responses” is used to refer to responses that are pre-verbal only, or both pre-verbal and pre-conscious.

An aspect of the invention is the presentation of an experimental task or series of tasks to one or more subjects to elicit pre-verbal and pre-conscious responses to external stimuli. These tasks are adapted from experimental protocols developed in the academic literatures of experimental psychology, social psychology, and neuroscience, and the clinical literature and practice of neurology. Their purpose is to present stimuli to subjects in experimental contexts in which potentially confounding factors are controlled and results are accurately measured for significance and effect size.

As used herein, “experimental tasks” includes both individual and group tasks; that is, tasks a subject performs alone and tasks a subject performs while interacting with other subjects or individuals outside the experimental group; for example, an audience.

Example protocols include, but is not limited to, any of the following, or a combination of any of the following:
(a) Visual Search protocol—in which a subject searches for a target stimulus in a grid or field of distracter stimuli (Horowitz, T. et al. (2006). Visual search deficits in Parkinson's disease are attenuated by bottom-up target salience and top-down information. Neuropsychologia, 44(10), 1962-1977.)
(b) Rapid Serial Visual Processing (RSVP) protocol—in which attentional and goal-oriented variations in brain activity responses to visual and semantic stimuli are measured and compared prior to and following exposure to target continuous stimuli.
(c) Implicit Attitude Test protocol—in which a subject is confronted with a categorization task that includes potentially conflicting semantic or visual stimuli that activate different associative networks in memory and produce variations in response times (Brunel, F. et al. (2004). Is the Implicit Association Test a Valid and Valuable Measure of Implicit Consumer Social Cognition? Journal of Consumer Psychology, 14(4), 385-404.).
(d) Sequential Priming protocol—in which a subject is exposed subliminally or consciously to a word or image which may influence a subsequent categorization task (Greenwald, A. et al. (1989). Unconscious processing of dichoptically masked words. Memory and Cognition, 17, 35-47.).
(e) Pair or Group Interaction protocol—in which s subject interacts with one or more other subjects, or a confederate impersonating a subject, or a computer program simulating a subject, while engaging in activities such as negotiating, cooperating, competing, or performing a transaction (Sanfey, A. et al. (2003). The Neural Basis of Economic Decision-Making in the Ultimatum Game. Science, 300(13), 1755-1758.)

These and other protocols are assembled into experimental tasks that are included in an aspect of the invention. The following examples represent an illustrative, partial, and non-exhaustive list of exemplary experimental tasks that can be implemented in different embodiments of the invention.

In an embodiment, to generate a data stream measuring a subject's pre-verbal and pre-conscious responses to product packaging alternatives, the following steps might be performed in an experimental session:
(1) An implicit attention task, in which the subject counts alternative product packaging images in a context of distracter image on a screen.
(2) A reaction time task, in which the subject visually locates and clicks on a product image in a grid of like or unlike images, where the grid size varies between exposures.
(3) An explicit self-reporting task, in which the subject records beliefs, opinions and preferences about alternative product packaging designs while visually examining alternative product packaging images.

In an embodiment, to generate a data stream measuring a subject's pre-verbal and pre-conscious responses to alternative product benefit statements, the following steps might be performed in an experimental session:
(1) A pre-exposure benchmarking RSVP task, in which the subject is incidentally exposed to words or images associated with different possible product benefits, while engaged in a distracter categorization task.
(2) A problem reaction task, in which the subject is asked to vicariously experience a problem state associated with a given benefit.
(3) A benefit reaction task, in which the subject reads a benefit statement providing a solution to the vicariously experienced problem.
(4) An explicit self-reporting task, in which the subject records beliefs, opinions and preferences about alternative benefit statements.
(5) A post-exposure RSVP task, in which the subject is incidentally exposed to words or images associated with problems and benefits presented in the reaction tasks, while engaged in a distracter categorization task.
(6) A memory testing test, in which the subject is asked to spontaneously recall and recognize from a list of true and false candidates, problems and benefits presented earlier in the experimental session.

In an embodiment, to generate a data stream measuring a subject's pre-verbal and pre-conscious responses to an online information search experience, the following steps might be performed in an experimental session:
(1) A pre-exposure benchmarking RSVP task, in which the subject is incidentally exposed to words or images associated with different possible online search topics and objects that might be encountered as part of a search, while engaged in a distracter categorization task.
(2) A search topic selection task, in which the subject selects a question to answer using an online search.
(3) A search term selection task, in which the subject selects a search term to perform the search.
(4) A search task, in which the subject attempts to find an answer to the selected search question.
(5) An explicit self-reporting task, in which the subject records beliefs, opinions and preferences about the quality and effectiveness of the search task.
(6) Additional cycles through steps (1)-(4) until a series of search topics have been completed.
(7) A post-exposure RSVP task, in which the subject is incidentally exposed to words or images associated with different online search topics and objects that might have been encountered as part of searching, while engaged in a distracter categorization task.
(8) A memory testing task, in which the subject is asked to spontaneously recall and recognize from a list of true and false candidates, objects or messages that might have appeared as part of the online search tasks performed.

In an embodiment, to generate a data stream measuring a subject's pre-verbal and pre-conscious responses to product auditory attributes, such as a mechanical sound, the following steps might be performed in an experimental session:
(1) An eyes-closed listening task, in which the subject listens to a series of product attribute sounds in a randomized sequence with other affective sounds that have been previously benchmarked for valence and arousal.
(2) An eyes-open listening and visual inspection task, in which the subject listens to the product attribute sounds while viewing an image of the product.
(3) An explicit self-reporting task, in which the subject records beliefs, opinions and preferences about the sounds, as well as inferences about the products associated with the sounds.

In an embodiment, to generate a data stream measuring a subject's pre-verbal and pre-conscious responses to product olfactory attributes, such as a scent or fragrance, the following steps might be performed in an experimental session:
(1) An eyes-open olfaction task, in which the subject inhales the smell of product samples in a randomized sequence for a set period of time.
(2) A second eyes-open olfaction task, in which the subject re-samples the product smells for a self-determined period of time.
(3) An explicit self-reporting task, in which the subject voluntarily re-samples the product smells while recording beliefs, opinions and preferences about the smells, as well as inferences about the products associated with the smells.

In an embodiment, to generate a data stream measuring a subject's pre-verbal and pre-conscious responses to alternative television advertisements, the following steps might be performed in an experimental session:
(1) A pre-exposure benchmarking RSVP task, in which the subject is incidentally exposed to words or images associated with alternative advertisements and objects that might be encountered as part of the advertisements, while engaged in a distracter categorization task
(2) A TV program viewing task, in which the subject views TV programs or program segments with simulated “ad breaks” in which the alternative advertisements are presented in a randomized order without indication to the subject that they are the object of the experiment.
(3) A post-exposure benchmarking RSVP task, in which the subject is incidentally exposed to words or images associated with the alternative advertisements and objects encountered as part of the advertisements, while engaged in a distracter categorization task.
(4) An explicit self-reporting distracter task, in which the subject records beliefs, opinions and preferences about the viewed TV programming segments.
(5) A memory test, in which the subject is asked to spontaneously recall and recognize from a list of true and false candidates, products, brands and other objects presented in the advertisements viewed earlier in the experimental session.
(6) An explicit self-reporting advertisement evaluation task, in which the subject is asked to view the target advertisements again and fill out a questionnaire recording beliefs, opinions, and preferences regarding the viewed advertisements.

In an embodiment, to generate a data stream measuring a subject's pre-verbal and pre-conscious responses to a product-related message, and further, to determine the impact of those responses on the subject's likelihood of purchasing the product, the following steps might be performed in an experimental session:
(1) A TV program viewing task, in which the subject views TV programs or program segments with simulated “ad breaks” in which the alternative advertisements are presented in a randomized order without indicating to the subject that advertisements are the actual object of the experiment.
(2) An explicit self-reporting distracter task, in which the subject records beliefs, opinions and preferences about the viewed TV programs or segments.
(3) A memory recall test, in which the subject is asked to spontaneously recall any products or brands presented in the advertisements viewed earlier during the TV program viewing task.
(4) A memory recognition test, in which the subject is asked to identify brands advertised during the TV program viewing task, selecting from a list of similar brands in the same product category.
(5) A purchase intention and preference task, in which the subject selects a preferred product to purchase in each category from among the candidates presented in the prior memory recognition test.
(6) An purchase decision task, in which the subject is offered a fixed number of discount purchase coupons that can be distributed in any combination among the products in each category. The subject's distribution of coupons represents his or her likely future purchase behavior with regard to the presented set of similar products in each category.

An aspect of the invention is a system of sensors and recording and analysis devices through which neural signals and physiological signals are collected.

In an embodiment, a physical system comprising an array of sensors and measurement devices is deployed around and coupled to an individual (the subject). The term “coupled” refers to any method of connecting a sensor to an individual, including wired and wireless connections, and invasive and non-invasive connections. In one embodiment, the system is assembled in a research facility or laboratory, but may be assembled in other settings as well.

The number of subjects coupled to the system as one time may include one, two, or more subjects. These subjects may be engaged in individual tasks, in which they are not interacting with each other, or group tasks, in which they are interacting with each other through cooperation, coordination, competition, or some other form of interaction. They may also be engaged in tasks in the presence of individuals who are not subjects in the experiment, for example, an audience.

The subject or subjects may interact with the system while sitting, standing, lying down, or moving about in an environment.

The set of sensors and measurement devices may include, but is not limited to, any of the following, or a combination of any of the following devices:
(a) Continuous digital Electroencephalography (EEG) recording device—to measure changes in electrical activity such as brainwave frequency power changes, coherence and oscillation changes, and event-related synchronization and desynchronization in the brain associated with changes in attention, emotional reaction, and higher cognitive processing while experiencing stimuli in real time.
(b) Event Related Potential (ERP) recording device—to measure millisecond-by-millisecond brain processing responses to repeated time-locked visual and semantic stimuli associated with, or included as part of, target continuous stimuli.
(c) Electromyography (EMG) recording device—to measure macro- and micro-level facial muscle movement, a reliable non-verbal indicator of positive or negative emotional reactions.
(d) Electrodermal Activity (EDA) recording device—to measure changes in skin conductivity associated with emotional arousal, interest, and engagement.
(e) Eye—Tracking and Gaze Fixation recording device—to track eye movements, including saccadic eye movements, to measure precisely when and where vision is focused on a complex visual stimulus such as an ad, video, film, television program, image, or web page.
(f) Pupillary Dilation and Blink Response recording device—to measure changes in pupil diameter, blink rates, startle responses, and reaction times as indicators of attention, interest, and engagement over time.
(g) Electrocardiogram (EKG) recording device—to measure contractile activity of the heart, including heart rate, inter-beat intervals, and heart rate variability over time.
(h) Respiration recording device—to measure changes in depth and rate of breathing, an indicator of emotional response to stimuli.
(i) Reaction Time recording device—to measure subjects' reaction times to different combinations of stimuli to determine relative attentional resource allocation under conditions of competing stimuli.
(j) Video Recording device—to capture facial expressions and body movement during the experimental session.
(k) Voice Recording device—to capture verbal responses to stimuli.
(l) Data Analysis and Metric Production device—a hardware and software computer system to store and process combined data streams and apply analytic algorithms to produce metrics describing pre-verbal and pre-conscious brain responses to stimuli.

An aspect of the invention is a method and system for data acquisition and analysis of the acquired data.

In an embodiment of the invention, a system comprised of sensors, recording devices, and computer instructions on a storage medium are employed in a sequence of steps to collect and process a data stream that serves as input into an analysis and measurement calculation process that is carried out in a sequence of steps.

Recording, analysis, and metrics generation in an embodiment of the invention may be comprised of any of the following, or a combination of any of the following steps:

In preparation for recording, subjects are fitted with an electrode cap (201) comprised of 20 to 256 electrodes, connected to an electrical signal amplifier (202) (for example, the EEG data collection system from Advanced Neuro Technologies, Inc.), connected to a computer (203) for recording brain signals and a software program (204) for EEG data acquisition (for example, ASA from Advanced Neuro Technologies, Inc.). To measure EDA through skin conductance response, the subject is connected to a bipolar skin conductance sensor (205) attached to two fingertips of the left hand, which is also connected the (202) electrical signal amplifier. To measure EMG, a bipolar sensor (206) is placed on the subject's face to the left and right of the corrugator muscle, located between the eyebrows, and connected to an electrical signal amplifier (202). To measure Respiration, (207) a rubber belt is placed around the subject's chest and connected to an electrical signal amplifier (202). To measure EKG, two sensors (208) are placed on the subject's chest and connected to an electrical signal amplifier (202).

EEG, ERP and RSVP measures are calculated in post-processing of the EEG signal captured by (201). Gaze tracking and pupillary dilation are measured by an eye-tracking monitor (209) with supporting software (210) running (for example, the Tobii Technologies 2150 monitor and ClearView 2.7 software) on a data acquisition computer (211) dedicated to capturing the eye tracking data stream.

Visual and auditory stimuli are presented to the subject using (212) a commercial stimulus presentation package (for example, eevoke from Advanced Neuro Technologies, Inc.). The subject experiences the visual/auditory stimuli and engages in various actions defined by the experimental protocol using (213) a computer mouse and keyboard.

The stimulus presentation may include any or all of the following visual, auditory, or other sensory components: (221) video of advertisements, (222) video of entertainment programs, (223) dynamic web pages, (224) tasks to be performed in computer software applications, (225) immersive environments or video games, (226) images of products, logos, or brands, (227) word lists referencing concepts associated with any of the above, (228) physical products, (229) taste sensations, (230) olfactory sensations, (231) tactile sensations, and other sensory components as required by the needs of the experimental task.

Neurological and physiological data are recorded on a multiplicity of data collection modalities (EEG, ERP, EMG, EDA, eye tracking, pupillary dilation, heart rate, respiration, reaction time, video recording, voice recording) before, during, and after stimuli presentation associated experimental tasks are performed by the subject.

Following completion of the data acquisition, the subject is disconnected from the data collection devices and the data collection session is concluded. All data streams are backed up on an archival storage computer (301). Data is then prepared for synchronization, consolidation, data reduction, and analysis.

Synchronization and consolidation of visual data consists of the following steps: eye gaze location data, eye gaze fixation data, and mouse click data from the eye tracking software (210) is merged with the EEG data stream stored in the EEG recording computer (203). EDA, EMG, EKG, and Respiration are merged in the synchronized dataset with the visual data and EEG.

RSVP and ERP results are derived from the raw EEG data using analytic software (302) (such as ASA from Advanced Neuro Technologies, Inc.). The process of reducing the raw data to ERP and RSVP outputs consists of the following steps: (303) re-referencing the sensor channels to an average reference montage, (304) bandpass filtering the electrical signals, (305) correcting the channel signals for eye blinks and facial muscle movements, (306) manually disabling any channels exhibiting unstable signals or excessive electrical noise, (307) interpolating any disabled channels, (308) detecting and rejecting artifacts above and below specified frequency levels, (309) identifying data epochs based on coded triggers in the data stream, and (310) creating conditions representing the various stimulus types, (311), averaging the signals within each condition, and (312) detrending the averaged data.

All data streams are stored in an analytic software programming environment (321) (for example, MATLAB from The MathWorks, Inc.). Data is consolidated and “triangulated” using custom software programs (322) that align and synchronize neurological and physiological datasets across all modalities at millisecond time intervals. Metrics for pre-verbal and pre-conscious responses to stimuli are calculated for each subject using statistical and data reduction algorithms (323) developed for that purpose.

Results collected from multiple subjects are grand-averaged and combined into a dataset (324) that aggregates and summarizes independent and dependent variables relating to target stimuli. Aggregated results are calculated and analyzed for validity and statistical significance (325).

Results are collected into a written report (331) describing the range and depth of pre-verbal and pre-conscious responses to stimuli for the sample of subjects tested. In addition, results are stored in a normative database of findings (332) that can be used for cross-stimuli comparisons and trend analyses (333).

An aspect of the invention is a method and system for the calculation of specific metrics, also referred to as neurometrics, that identify components of subjects' individual and aggregated responses.

In this aspect of the invention, computer instructions on a storage medium are used to produce metrics from the data acquisition and analysis process. These metrics, also referred to as implicit response metrics, include, but are not limited to, any of the following, or a combination of any of the following metrics of pre-verbal and pre-conscious responses to external stimuli:
(a) Attention/Attraction metrics—comparative metrics of the degree to which a stimulus attracts attention in a given context, relative to other stimuli in the same context. Example uses include, but are not limited to: comparing package designs for shelf noticeability; determining which TV advertisements stands our best in an ad pod; measuring which online ad attracts the most attention on a web page.
(b) Implicit Emotional Response metrics—comparative metrics of the degree to which an emotional reaction, measured in the two dimensions of valence and arousal, is being raised by a stimulus. Example uses include, but are not limited to: determining whether an emotional appeal is being transmitted to an audience; determining whether a difficult to articulate emotional response is occurring; identifying emotional reactions to a product or brand that occur below the level of conscious awareness; identifying whether a product, brand or message is perceived as interesting or engaging by an audience.
(c) Sensory Experience metrics—comparative metrics of how people respond emotionally and cognitively to sensory experiences other than visual; i.e., auditory, olfactory, gustatory, and tactile. Example uses include, but are not limited to: quantifying consumers' reactions to sounds, smells and tastes that are difficult or impossible to articulate verbally; identifying how experiences that span multiple senses aggregate into a single positive or negative experience; quantifying relative reactions to sensory stimuli that may be below the level of conscious awareness.
(d) Benefit Assessment metrics—comparative metrics of the relative strength and direction of implicit cognitive and emotional reactions to problem and benefit statements. Example uses include, but are not limited to: comparing and rank-ordering responses to problem and benefit statements ascribed to products and brands, especially for topics people have difficulty evaluating verbally, due to sensitivity or ambiguity; determining the extent to which self-reported salience of benefit statements matches or contradicts implicitly measured salience.
(e) Memorability metrics—comparative metrics of the extent to which different stimuli activate long-term memory processes in the brain, including both retrieval and retention of long-term memories. Example uses include, but are not limited to: determining which of a set of stimuli are most likely to be remembered.
(f) Expectancy Violation metrics—metrics of congruence or consistency between temporally, conceptually, or physically adjacent stimuli. Example uses include, but are not limited to: determining how well semantic elements of a value proposition “fit together” in a subject's mind; identifying the extent to which a web page meets the expectations generated by the page linking to it; determining whether a message or package fits expectations for a brand; measuring whether advertising copy meets audience needs for consistency and comprehension; identifying the maximum acceptable price point for a product.
(g) Experience After-Effect metrics—metrics of the extent to which an extended experience, such as performing a web search, viewing an entertainment program, reading email messages, or playing a computer game, impacts later salience and responsiveness to objects, including products and messages, embedded in the experience. Example uses include, but are not limited to: identifying the later impact of ads and product placements in online, gaming, entertainment, or task-related experiences; determining how an extended experience impacts memory, attention and emotional response to later messages referencing elements in the experience.

An aspect of the invention is a method and system for combining implicit response metrics with explicit response metrics, the latter including verbal, written, and instrument-mediated conscious responses to stimuli.

In an embodiment of the invention, implicit response metrics are used as independent variables to predict, explain, or validate metrics that measure conscious beliefs, opinions, attitudes and behaviors, also call explicit response metrics, that are useful to product developers and marketers, such as product preferences, purchase decisions and inclusion in product consideration sets.

Examples of metrics that integrate implicit response metrics with explicit response metrics include, but are not limited to, any of the following, or a combination of any of the following:
(a) Preference Formation metrics—metrics describing the extent to which exposure to external stimuli results in forming or changing preferences for objects and ideas, including products and brands, referenced or incorporated in a stimulus. Example uses include, but are not limited to: identifying how and to what extent pre-verbal and pre-conscious responses to products and messages contribute to forming or shifting preferences in consideration sets, purchase intent, or product rankings; determining the impact of implicit emotional responses on preference formation; determining the impact of attentional attractiveness on preference formation; determining the impact of pricing levels on preference formation.
(b) Buying Decision metrics—metrics describing actual or simulated buying behavior following exposure to external stimuli. Example uses include, but are not limited to: identifying how and to what extent pre-verbal and pre-conscious responses to products and messages contribute to buying behaviors, as measured by direct choices and simulated choices in real and virtual buying environments.
(c) Self-Report Validation metrics—metrics in which subjects' voluntary self-reported responses are compared to and evaluated against pre-verbal and pre-conscious metrics. The purpose of these measures is to calibrate the extent to which self-reports deviate from pre-verbal and pre-conscious measures of response. Example uses include, but are not limited to: creating a validation scorecard for assessing the degree to which self-reports should be relied upon for decision making regarding acceptance or approval of product designs, packaging, advertising, or other messaging.

An embodiment of the invention can be utilized in any context in which pre-verbal and pre-conscious responses to external stimuli would be useful for some analytical purpose. Example uses include, but are not limited to, responses to brands and products, responses to graphic and industrial designs, responses to semantic formulations and messages, responses to political phrasings and terminology, responses to individuals such as political or business figures, responses to objects in virtual reality environments or immersive gaming environments, within-subject or within-group longitudinal responses to a single stimulus over time, responses to in-store layouts and designs, responses to print and online media presentations, responses to education, training and learning approaches, and truth detection.

While different embodiments of the present invention has been illustrated and described, it would be obvious to those skilled in the art that various changes and modifications can be made without departing from the spirit and scope of the invention. It is therefore intended in the appended claims all such changes and modifications that are within the scope of this invention.

What is claimed is:

1. A system for evaluating a set of select responses of a human subject exposed to commercialization-related stimuli, the system comprising:
(a) data comprising at least one experimental task to be presented to the human subject;
(b) a set of sensors coupled to the human subject; and
(c) computer instructions on a storage medium that, based on at least a portion of the information received from the set of sensors, determines at least one metric corresponding to the set of select responses.

2. The system of claim 1, wherein select responses of a human subject include any of the following, or a combination of the following, responses:
(a) pre-verbal responses;
(b) pre-conscious responses.

3. The system of claim 1, wherein data is further comprised of recorded responses to external stimuli of any sensory modality, consisting of any of the following, or any combination for the following:
(a) visual;
(b) auditory;
(c) olfactory;
(d) gustatory;
(e) tactile.

4. The system of claim 1, wherein experimental tasks are further comprised of experimental protocols, consisting of any of the following, or a combination of any of the following:
(a) visual search protocols;
(b) rapid serial visual processing protocols;
(c) implicit attitude test protocols;
(d) sequential priming protocols;
(e) pair or group interaction protocols.

5. The system of claim 1, wherein experimental tasks further include any of the following, or a combination of any of the following:
(a) implicit attention tasks;
(b) conflicting stimuli reaction time tasks;
(c) explicit self-reporting tasks;
(d) pre- and post-stimuli exposure RSVP tasks;
(e) problem statement reaction tasks;
(f) benefit statement reaction tasks;
(g) value proposition reaction tasks;
(h) memory testing tasks;
(i) auditory stimuli listening tasks;
(j) olfactory stimuli smelling tasks;
(k) gustatory stimuli tasting tasks;
(l) tactile stimuli touching tasks;
(m) entertainment program viewing tasks;
(n) online activity performance tasks;
(o) immersive game play tasks;
(p) explicit self reporting tasks;

6. The system of claim 5, wherein explicit self-reporting tasks further include any of the following, or a combination of any of the following:
(a) product or brand preference identification tasks;
(b) purchase decision tasks;
(c) product evaluation tasks;
(d) product design and packaging evaluation tasks;
(e) message and advertising evaluation tasks.

7. The system of claim 5, wherein memory testing tasks include any of the following, or a combination of any of the following:
(a) spontaneous recall testing tasks;
(b) prompted recognition testing tasks.

8. The system of claim 1, wherein sensors coupled to the subject are connected to recording devices, including any of the following, or a combination of any of the following:
(a) continuous digital electroencephalography (EEG) recording device;
(b) event related potential (ERP) recording device;
(c) electromyography (EMG) recording device;
(d) skin conductance response (SCR) recording device;
(e) eye-tracking and gaze fixation recording device;
(f) pupillary dilation and blink response recording device;
(g) electrocardiogram (EKG) recording device;
(h) respiration recording device;
(i) reaction time recording device;
(j) video recording device;
(k) voice recording device;
(l) data analysis and metric production device.

9. The system of claim 8, wherein sensors coupled to the subject include any of the following, or a combination of the following:
(a) wired connections;
(b) wireless connections;

10. The system of claim 1, wherein metrics are further comprised of pre-verbal and pre-conscious response metrics, including any of the following, or a combination of any of the following:
(a) attention/attraction metrics;
(b) implicit emotional response metrics;
(c) sensory experience metrics;
(d) benefit assessment metrics;
(e) memorability metrics;
(f) expectancy violation metrics;
(g) experience after-effect metrics.

11. The system of claim 1, wherein metrics are further comprised of pre-verbal and pre-conscious response metrics, combined with conscious response metrics, to produce metrics including any of the following, or a combination of any of the following:
(a) preference formation metrics;
(b) buying decision metrics;
(c) self-report validation metrics.

12. A method for evaluating a set of select responses of a human subject exposed to commercialization-related stimuli, the method comprising:
(a) using a set of devices to present at least one experimental task to the human subject;
(b) receiving information from a set of sensors coupled to the human subject;
and
(c) based on at least a portion of the information, determining at least one metric corresponding to the set of select responses.

13. The method of claim 12, wherein determining at least one metric corresponding to the set of select responses of a human subject to external stimuli includes any of the following, or a combination of any of the following, steps:
(a) presenting experimental tasks to the human subjects;
(b) receiving information from a set of sensors coupled to the subjects and connected to a set of recording devices;
(c) performing a sequential process of data acquisition, synchronization, reduction, and analysis to consolidate collected data;
(d) determining at least one metric corresponding to the set of select responses;
(e) determining at least one metric including, in addition to at least one metric corresponding to the set of select responses, at least one conscious response metric derived from conscious responses to external stimuli.

14. The method of claim 13, wherein step (b) includes signal data collected before, during, or after exposure to external stimuli.

15. The method of claim 13, wherein step (c) is further comprised of a sequence of data acquisition, synchronization, reduction, and analysis steps, including any of the following, or a combination of any of the following steps:
(a) coupling subjects to sensors connected to recording devices;
(b) directing subjects to perform experimental tasks;
(c) exposing subjects to sensory stimuli;
(d) collecting data from sensors coupled to subjects and connected to recording devices;
(e) disconnecting subjects from recording devices;
(f) backing up data streams on an archival storage device;
(g) synchronizing and consolidating data from multiple recording devices;
(h) reducing data to aggregated measures for further analysis;
(i) analyzing synchronized, reduced, and aggregated data in an analytic software programming environment;
(j) calculating metrics of pre-verbal and pre-conscious responses to target stimuli for each subject;
(k) calculating metrics of conscious responses to stimuli for each subject;
(l) combining results for multiple subjects into a single dataset;
(m) combining pre-verbal and pre-conscious response metrics with conscious response metrics;
(n) performing statistical tests to estimate the strength and generalizability of associations among stimuli and responses to stimuli in the subject sample;
(o) preparing a report of findings and results;
(p) storing results in a normative database of findings;

16. The method of claim 15, wherein step (c) includes any of the following, or a combination of any of the following sensory stimuli:
(a) visual;
(b) auditory;
(c) olfactory;
(d) gustatory;
(e) tactile.

17. The method of claim 15, wherein step (g) is further comprised of synchronizing and consolidating multiple data streams, including any of the following, or a combination of any of the followings:
(a) eye movement and gaze fixation data;
(b) continuous EEG brain activity data;
(c) EMG facial muscle activation data;
(d) EDA skin conductance data;
(e) pupil dilation data;
(f) eye blink and startle response data;
(g) heart activity data;
(h) respiratory activity data;
(i) experimental task reaction time data;
(j) video recording data;
(k) audio recording data.
